(19) United States
(12) Patent Application Publication
(10) Pub. No.: US 2015/0140255 A1
(43) Pub. Date: May 21, 2015

(54) JOINING OF TEXTURED SHEET MATERIALS

(71) Applicant: Ray Arbesman, Toronto (CA)

(72) Inventor: Winston MACKELVIE, Knowlton (CA)

(21) Appl. No.: 14/543,139

(22) Filed: Nov. 17, 2014

(30) Foreign Application Priority Data
Nov. 18, 2013 (CA) 2833495

(51) Int. Cl. B23P 19/04; B32B 7/08

(52) U.S. Cl. CPC B23P 19/04; B32B 7/08; B32B 2250/44
USPC 428/61; 29/521; 29/283.5

(57) ABSTRACT

A method is provided for joining textured sheet materials. Complementary edges of two sheets of textured sheet material are aligned in an adjacent fashion. A joining element is positioned along at least a portion of the textured surfaces of the two sheets so as to cover at least a portion of the exposed piercing elements and so as to at least partially bridge the gap between the edges of the two pieces. By rolling or pressing on the joining element to force the piercing elements of the textured surfaces into the joining element, the joining element thus connects the two sheets to form a joint. The method can also be used with laminated sheets or to form a laminate after the sheets are joined. A kit for joining is also provided. A method for joining continuously-fed textured sheet material is also provided.

### CROSS-REFERENCE TO RELATED APPLICATIONS

This application claims benefit of Canadian patent application number 2,833,495, filed Nov. 18, 2013, which is herein incorporated by reference.

### FIELD OF THE INVENTION

A method is provided for joining sheet materials and in particular sheet metal.

### BACKGROUND OF THE INVENTION

Current methods of joining sheet material typically involve fasteners, adhesives or heat (soldering, brazing, welding). These methods are difficult to implement on large sheets and long edges. They require a lap joint where the thickness of the joined material is increased. In the case of heat joining there is often warping or other distortion.

It would be desirable to have a simple method for joining sheet materials.

Further, textured sheet material is becoming more readily available (including NRX® material made by Nucap Industries Inc.). Such material is available in roll formats and various sizes of sheets. However, large widths may be more difficult to accommodate and/or transport. It would be desirable to provide a method of side-by-side joining of such material to enable larger pieces or custom sizes to be manufactured on site. It would also be desirable to provide a method of side-by-side joining for temporary use (e.g. in transportation and material handling).

Full laminates of such materials have been proposed, but it would also be desirable to use the piercing elements of the textured materials to form a joint (e.g. a side-by-side joint).

### SUMMARY OF THE INVENTION

According to a first aspect of the invention, a method is provided for joining textured sheet materials. Complementary edges of two sheets of textured sheet material are aligned in an adjacent fashion. Each sheet has a textured surface with a plurality of raised piercing elements. The sheets are aligned such that at least some of the piercing elements are exposed on the surface near the aligned edges and face up. A joining element is positioned along at least a portion of the textured surfaces of the two sheets so as to cover at least a portion of the exposed piercing elements and so as to at least partially bridge the gap between the edges of the two sheets. By rolling or pressing on the joining element, the piercing elements of the textured surfaces are forced into the joining element, and the joining element thus connects the two sheets to form a joint.

At least one of the two sheets may have other piercing elements that are not covered by the joining element and remain exposed.

The joining element may be made of any ductile (relatively non-brittle) material. Examples include various metals and plastics, and other materials such as wood. The material of the joining element can be selected to be compatible with the sheets to be joined and any lamina to be applied.

Preferably, the sheets are made of hard material (relative to the joining element). Where the piercing elements are to be invisibly embedded in the joining material then preferably the joining material is softer than the sheet material. Where the piercing elements are to pierce through the joining material (e.g. for riveting or clinching) then preferably the joining material is thinner than the sheet material.

In one embodiment, the joining element is a strip of foil. Preferably, the thickness of the foil strip is less than 0.25 mm (0.010 inches), and preferably between 0.05 and 0.25 mm (0.002 and 0.010 inches) thick. For example, the foil strip may be made of thin aluminum or steel, or a laminate-compatible plastic.

The joint may stay flat, and/or the joining element may be selected to allow folding or torsion between the two pieces. The joining element may be pre-folded or bent before formation of the joint.

In one embodiment, the joining element includes an adhesive. The piercing elements embed into (and may extend through) both the adhesive and the joining element in the rolling step. An adhesive may be applied to either of the joining element or the textured surface prior to the rolling or pressing step.

The rolling or pressing step may result in the piercing elements piercing through the joining element.

The rolling or pressing step may result in the piercing elements being bent over or clinched under the force of the rolling or pressing.

In one embodiment (such as that using thin foil), the joining element may be dispensed from a roll.

The joining element may be cuttable by hand. The joining element may be tearable by hand.

The joining element may be a foil strip. The foil strip is preferably thinner than sheets to be joined. The thickness of the foil may be less than 0.25 mm (0.010 inches).

The rolling or pressing step may be done by one or more rollers applied to the joint. In one embodiment, the rollers are rubberized to force the joining element (e.g. thin foil) down into secure contact with the surface of the sheet while permitting the piercing elements to emerge through the joining element. In another embodiment, the rollers may be metal rollers wherein their hard surface crushes or clinches the piercing elements to effectively form rivets holding the joining element to the sheets. In another embodiment, secondary metal rollers may be used to crush or clinch the piercing elements to effectively form rivets to provide a stronger joint. In one embodiment, the rollers are applied by hand.

Each sheet may have two textured surfaces. A joining element may bridge the joint on one or both faces of the sheets.

The method may further comprise adding a lamina of ductile material over at least a portion of the joined sheets, or two sheets of material may be joined that have previously had a lamina of ductile material applied. Laminated products and materials formed according to the methods herein are also provided.

The joining element may be relatively thin (i.e. same or less thickness than the sheets themselves) to make a relatively flush joint. This may be preferred to allow a lamina to be applied over the joint with little visible or perceptible interruption.

According to a second aspect of the invention, a kit is provided for side-by-side joining of textured sheet materials. A length or roll of joining material (e.g. foil) is provided from which a strip may be cut. The strip is adapted to be applied to a pair of sheets of textured sheet material, which have been aligned in side-by-side fashion along complementary edges (each sheet comprising a cut sheet of material having a textured surface with a plurality of raised piercing elements), and which have been aligned such that at least some of the piercing elements are exposed on the surface near the aligned edges and face up. The strip is adapted to be applied along at least a portion of the textured surfaces of the two sheets so as to cover at least a portion of the exposed piercing elements and so as to at least partially bridge the gap between the edges of the two sheets. The kit also includes a rolling or pressing tool for applying pressure on the strip to embed the piercing elements of the textured surfaces into the strip, such that the strip can retain the two pieces together at a joint. The kit may provide for coil handling equipment to supply sheet material to be joined and fed continuously into another process (e.g. a roll-based laminating system).

According to a third aspect of the invention, a method is provided for joining textured sheet material. Two continuous lengths of textured sheet material are fed from a supply. The textured sheet material has a textured surface with a plurality of raised piercing elements. The lengths of textured sheet material are aligned in an adjacent fashion such that complementary edges of the lengths are aligned and such that at least some of the piercing elements are exposed on the surface near the aligned edges and face up. A joining element is fed into a position along at least a portion of the textured surfaces of the two lengths of textured sheet material so as to cover at least a portion of the exposed piercing elements and so as to at least partially bridge the gap between the edges of the two lengths. A rolling or pressing force is applied to the joining element to force the piercing elements of the textured surface into the joining element. The joining element thus connects the two lengths together at a joint.

### BRIEF DESCRIPTION OF THE DRAWINGS

FIG. 1 shows one embodiment where two sheets of metal are to be joined edge to edge. The sheets have raised piercing elements throughout one or both surfaces. A joining element (here, a strip of thin foil) bridges the gap between the sheets and is pierced so that the foil lies flat against the sheet's faces on both top and bottom.

FIG. 2 shows an end view of the same embodiment. On the bottom, the exposed tips of the piercing elements have been crushed to clinch or rivet them adding further strength to the joint.

FIG. 3 is a side view of a single piercing element showing the groove from which the piercing element (or burr) is raised.

FIG. 4 is a side view of a row of piercing elements.

FIG. 5 shows another embodiment where the piercing elements are selectively located and where short lengths of joining strips are used discontinuously along the joint with the possibility of holes used to add adhesive, and where a formed joining strip may be used to provide additional attachment means to other structures.

FIG. 6 shows the embodiment of FIG. 1 with dimpled holes in the foil joining strip that are filled with adhesive to form a ‘rivet head’ bigger in diameter than the hole, and where a substantial joining strip in the form of a wooden stud may be used to provide stiffened and means of attachment to other structures.

FIG. 7 shows a cross section of a joining strip with conical hole filled with adhesive to form a retaining rivet.

FIG. 8 shows a cross section of a joining strip on sheet material with a lamina added above.

FIG. 9 shows an end view of a rubber roller that presses the joining strip tight against the face of the sheet material by allowing the piercing elements' tips to enter the rubber.

FIG. 10 shows a side view of a possible laminating line with two coils of metal strip feeding the metal onto a table with piercing elements pointing up, and being joined with a narrow foil strip fed from a coil and where a rubber roller forces the foil onto piercing elements to join the metal strips, and another coil of lamina material being rolled onto the now-joined wider sheet.

FIG. 11 shows a top view where the two coils of strip metal are arranged side-by-side and the narrow coil of joining foil is fed and roll-forced over the respective piercing elements joining the two metal strips into a wider sheet.

### DETAILED DESCRIPTION

Piercing elements 4 are formed in the surface of a sheet material 1, 2 by toothed tooling that plows a short, shallow groove 4a from which a raised burr is necessarily created. For the instant joining process, these burrs are referred to as piercing elements 4. The piercing elements 4 have sharp tips 4b that can pierce into a softer or thinner material 3 when impaled thereon as in nailing. After piercing through, the tips can be crushed into form 4c to further secure the resulting joint. The crushed tip forms a shape similar to a rivet head and has a similar retaining effect as riveting. The tips can also be left uncrushed to allow for further materials to be added over the joint (e.g. as lamina in a laminated product). If an added lamina is thin enough then the protruding tips can be later crushed/clinched after the lamina has been added.

Processes for forming textured material with piercing or protruding elements on a bulk or continuous basis have been described, for example, in the application “Bulk Textured Material Sheeting”, Canadian Patent Application No. 2,778,455, of the same applicants, filed in Canada on May 29, 2012, or the process described for example in any of Canadian Patent Nos. 1,330,521, 1,337,622, or 2,127,339 (the disclosures of all of which are incorporated herein by reference). In these disclosures, integral hook-shaped structures are taught. Alternatively, more straight upright (e.g. nail-like) structures may be employed. These may be pre-bent into more hook-shape (or burr-like) structures. Such pre-bending can be done using rollers or a press arrangement between flat platens so as to bend the thinner tips over into hooks.

In the present application, such piercing elements are used to form butt joints between two pieces of sheet material. The piercing elements may be limited to the margins of the sheets or on the entire face or faces with those nearest the edges used in this process. The sheet material may be butt joined in either a side by side or end to end relationship. (Note that for the purposes of the present disclosure, the term “edge” is intended to mean any edge of a sheet, whether notionally positioned on an end or a side of the sheet, and whether straight, curved, jagged, flat or any configuration or shape whatsoever. Joints need only be formed of generally “complementary edges”, not limited to flat or parallel configurations.)

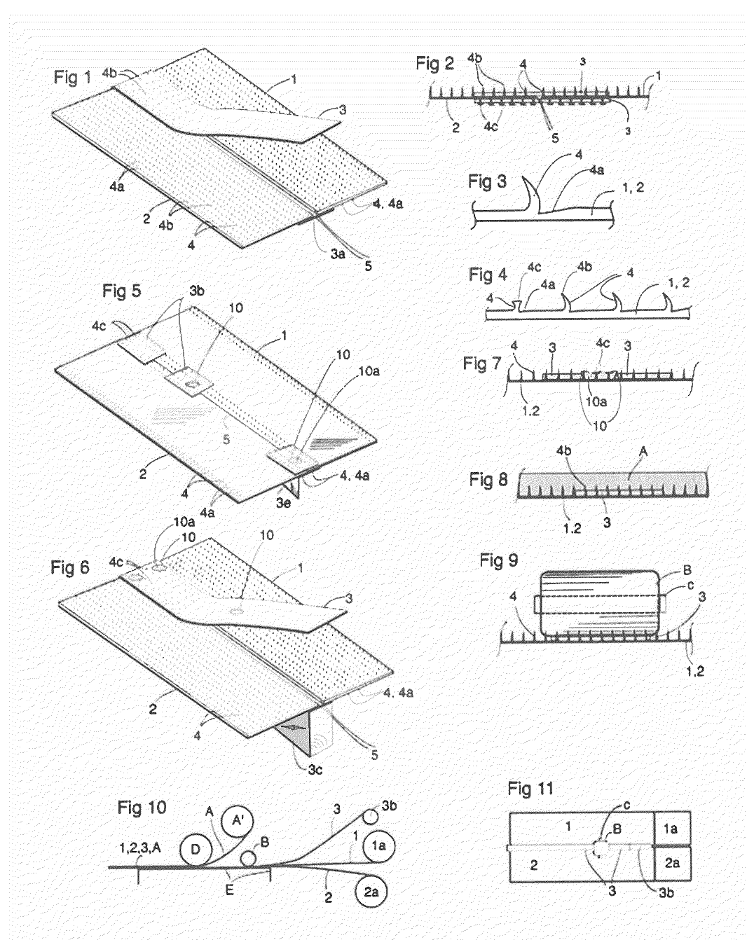

In all Figures the edges of sheets 1 and 2 abut to define a joint 5. The marginal areas along the edges of each sheet have rows of piercing elements 4 with tips 4b. The piercing elements 4 may be on one face as in FIGS. 3, 4 or, preferably, on both faces as indicated in FIGS. 1, 2, 5 and 6. Sheets 1, 2 may have piercing elements 4 covering the sheet's faces as in FIGS. 1, 2 or the piercing elements 4 may be located only in the margin of the edges 5 shown in FIGS. 2, 5. Further, the piercing elements 4 may be created in patches spaced along the margins as shown in FIG. 5.

A strip of foil 3 with a thickness of about 0.05-0.25 mm (0.002-0.010 inches) may be centered on edge to edge joint 5 bridging it. The foil strip 3 may be forced down onto piercing elements 4 so that tips 4b extend through the foil strip 3. The thin foil can be a very cheap and lightweight material. The foil can be a long strip or a series of short pieces/patches 3a, 3b of foil may be used as shown in FIG. 5.

The foil strip 3 may be pressed or rolled to cause the tips of the piercing elements to pierce through the foil strips thereby joining the sheets. The pressing or rolling may use rubberized rollers or rubber sheets, so that the tips are preserved while the foil is being fully impaled onto the piercing structures. Metal rollers may also be used to crush, clinch or rivet the exposed tips.

In some embodiments, tips 4b may be clinched or crushed to rivet heads 4c. Foil 3 can be metal or a polymer or even a fabric or tape.

The process of applying the foil strip 3 may be facilitated by the use of hard rubber into which the tips can extend after piercing through the foil. This ensures that the foil is fully seated against the sheet's face so as to minimize the effect thickening the region of the resulting joint. The hard rubber may be a roller of, for example hard urethane wheels such as is on a skate board (see, e.g., roller B on axel c in FIG. 9), or in strip or sheet form that can be peeled off the sheet for reuse.

Foil strip 3 can have holes 10 that are preferably at least slightly dimpled (or tapered) to create a wider mouth into the hole. Adhesive may be applied to fill these holes and thereby add strength when it cures into a shallow rivet head 10a bigger than the hole.

An adhesive may be applied to the margins before the foil 3 is applied combining bonding with the riveting with the adhesive rising through the holes 10. The adhesive itself hardens into a type of rivet head 10a, as shown in FIG. 7. A structural adhesive may be applied between the foil strips and the sheets as the rolling process is taking place. A low viscosity (penetrating) adhesive may also be applied after the rolling process. The adhesive may also be part of the foil (applied to the surface of the foil as an adhesive tape, or in the form of an adhesive-impregnated product).

Another embodiment of the process makes a form of laminate where strips of metal with raised piercing elements (faces sheets) are placed on either face of a softer sheet material (core) such as plastic or wood, and where the piercing elements enter the softer material but do not necessarily pierce through. Here too an adhesive may be effectively used between the strips and material. Additionally the strips may be provided with spaced holes preferably with a conical top shape. For example, the holes may be dimpled or countersunk. In this way adhesive can flow up into the holes and harden there to act as rivet heads to further increase the lamination strength.

The foil strip preferably runs just along the joined edges of the sheets. Other tips of piercing elements can thus be left exposed on the rest of the sheets. In this way the tips remain available for incorporation into other applied materials as the joined sheet materials will be used to make a laminate or composite material. FIG. 8 shows a sectional view of a joining strip 3 with lamina A applied above. The lamina may be applied by pressing onto the remaining exposed piercing elements, or it may be deposited or poured onto the piercing elements. The thin joint is preferably not visible from the outer surface of the lamina.

In this way a simple but surprisingly sturdy, cost effective joint can be used to join sheet materials such as steel.

The process can be modified to join sheet materials fed from coiled spools to create a wider coil of material. As shown in FIGS. 10 and 11, a laminating line can be provided with two coils 1a, 2a of metal strip feeding onto a table E with piercing elements (not shown) pointing up. These strips are joined by a narrow foil strip 3 fed from a coil 3b. A rubber roller B forces the foil onto piercing elements to join the metal strips. Another coil of lamina material A can also be rolled D onto the now-joined wider sheet. FIG. 11 shows a top view where the two coils 1a, 2a of strip metal are arranged side-by-side and the narrow coil of joining foil 3 is fed and roll-forced over the respective piercing elements (not shown) joining the two metal strips into a wider sheet.

Dissimilar materials may also be so joined.

Foil is but one type of possible joining element. The process can also be used favorably with thicker materials (e.g. wood beams or planks) where the thicker joining elements provide a structural component to the resulting joined assembly. For example, wood beams can act as framing posts, beams or joists (see, e.g., wood joining element 3c in FIG. 6) in a wall structure made up of sheets of textured material (and then the whole assembly can be laminated). Or, pre-laminated sheets can be joined with exposed piercing elements to form a wall of laminate.

Further, the joining element need not be straight or planar, but may be a bent or radiused element. Thus, the joint may allow flat sheets of textured material to be joined at a corner or angle. The joining element can be bent or radiused before or after the joint is formed (see, e.g., angled joining element 3e in FIG. 5).

The foregoing description illustrates only certain preferred embodiments of the invention. The invention is not limited to the foregoing examples. That is, persons skilled in the art will appreciate and understand that modifications and variations are, or will be, possible to utilize and carry out the teachings of the invention described herein. The scope of the claims should not be limited by the preferred embodiments set forth in the examples, but should be given the broadest purposive construction consistent with the description as a whole.

1. A method for joining textured sheet materials, the method comprising:
aligning in an adjacent fashion complementary edges of two sheets of textured sheet material, each sheet having a textured surface with a plurality of raised piercing elements, the sheets being aligned such that at least some of the piercing elements are exposed on the surface near the aligned edges and face up;
positioning a joining element along at least a portion of the textured surfaces of the two sheets so as to cover at least a portion of the exposed piercing elements and so as to at least partially bridge the gap between the edges of the two sheets; and
rolling or pressing on the joining element to force the piercing elements of the textured surfaces into the joining element, the joining element thus connecting the two sheets together at a joint.

2. The method of claim 1, wherein at least one of the two sheets has other piercing elements that are not covered by the joining element and remain exposed.

3. The method of claim 1, wherein the sheets are aligned in side-by-side fashion.

4. The method of claim 1, wherein the sheets are aligned at an angle to each other.

5. The method of claim 1, wherein the joint stays flat.

6. The method of claim 1, wherein the joint allows folding or torsion between the two pieces.

7. The method of claim 1, wherein the joining element is pre-folded or bent before formation of the joint.

8. The method of claim 1, wherein the joining element includes an adhesive, the piercing elements embedding into both the adhesive and the joining element in the rolling step.

9. The method of claim 1, wherein the rolling step results in the piercing elements piercing through the joining element.

10. The method of claim 1, wherein the rolling step results in the piercing elements being bent over or clinched under the force of the rolling or pressing.

11. The method of claim 1, further comprising applying an adhesive to either of the joining element or the textured surface prior to applying the joining element.

12. The method of claim 1, wherein the joining element is a foil strip.

13. The method of claim 12, wherein the foil strip is thinner than the sheets to be joined.

14. The method of claim 12, wherein the thickness of the foil is less than the height of the piercing elements.

15. The method of claim 12, wherein the thickness of the foil is less than 0.25 mm (0.010 inches).

16. The method of claim 12, wherein the foil is dispensed from a roll.

17. The method of claim 12, wherein the foil strip is cuttable by hand.

18. The method of claim 12, wherein the foil strip is tearable by hand.

19. The method of claim 1, wherein the rolling step is done by one or more rollers applied to the joint.

20. The method of claim 19, wherein the rollers are rubberized.

21. The method of claim 19, wherein the rollers are applied by hand.

22. The method of claim 1, wherein each sheet has two textured surfaces and to the joining element bridges the joint on one or both surfaces of the sheets.

23. The method of claim 1, wherein at least one of the sheets is pre-laminated with a lamina over at least a portion of its textured surface.

24. The method of claim 1, further comprising applying a lamina of ductile material over at least a portion of the joined sheets and embedding the lamina into at least a portion of the piercing elements on the textured surfaces.

25. A laminated product made according to the process of claim 23.

26. A kit for joining textured sheet materials, comprising:
a length or roll of joining material from which a strip may be cut, the strip being adapted to be applied to a pair of sheets of textured sheet material, the sheets having been aligned in adjacent fashion along complementary edges, each sheet having a textured surface with a plurality of raised piercing elements, and the sheets having been aligned such that at least some of the piercing elements are exposed on the surface near the aligned edges and face up, the strip being adapted to be applied along at least a portion of the textured surfaces of the two sheets so as to cover at least a portion of the exposed piercing elements and so as to at least partially bridge the gap between the edges of the two sheets; and
a rolling or pressing tool for applying pressure on the strip to embed the piercing elements of the textured surfaces into the strip, such that the strip can connect the two pieces together at a joint.

27. The kit of claim 26, wherein the joining material is a foil and the strips are foil strips.

28. A method of joining textured sheet materials, comprising:
feeding from a supply two continuous lengths of textured sheet material, the textured sheet material having a textured surface with a plurality of raised piercing elements;
aligning in an adjacent fashion the lengths of textured sheet material such that complementary edges of the lengths are aligned and such that at least some of the piercing elements are exposed on the surface near the aligned edges and face up;
feeding a joining element into a position along at least a portion of the textured surfaces of the two lengths so as to cover at least a portion of the exposed piercing elements and so as to at least partially bridge the gap between the edges of the two lengths; and
applying a rolling or pressing force to the joining element to force the piercing elements of the textured surface into the joining element, the joining element thus connecting the two lengths together at a joint.
